(19) United States
(12) Patent Application Publication
(10) Pub. No.: US 2020/0082420 A1
(43) Pub. Date: Mar. 12, 2020

(54) Smart Speaker Surveys

(71) Applicant: Concepts.io LLC, Sparta, NJ (US)

(72) Inventor: Jose Cotto, Sparta, NJ (US)

(73) Assignee: Concepts.io LLC, Sparta, NJ (US)

(21) Appl. No.: 16/128,475

(22) Filed: Sep. 11, 2018

(51) Int. Cl. G06Q 30/02; G06F 17/28; G10L 15/18; G10L 15/22; G10L 15/30

(52) U.S. Cl. CPC G06Q 30/0203; G06F 17/289; G10L 15/30; G10L 15/22; G10L 15/1822

(57) ABSTRACT

A smart speaker system is described, where the smart speaker is transformed into an interactive device for conducting surveys and for collecting paralinguistic metadata from the spoken words heard by the smart speaker device. The device uses a weighted word algorithm to determine the conviction and non-verbal meaning of the responses to the survey questions. The device is used for conducting political surveys, for the analysis of answers to medical questions, and for analyzing a consumer's response to marketing questions.

### BACKGROUND

### Technical Field

The system, apparatuses and methods described herein generally relate to a smart speakers and, in particular, to the transformation of smart speaker systems into a device for conducting surveys.

### Description of the Related Art

According to Voicebot.ai, smart speaker devices like the Amazon Echo and Google Home are installed in 22% of US households in 2018. At that time, over 54 million households have at least one of these smart speakers in their home in the US alone.

These smart speaker devices are very different from standard computers, requiring special designs and algorithms. Smart speakers lack visual output devices like screens, and do not have traditional input devices like keyboards, touchscreens, or mice. Instead, these devices need to be designed for audio input and output. All user interface inputs need to come into the device from a microphone, and all your interface outputs are delivered through a speaker. Voice analysis and parsing needs to be emphasized in the design, and clear voice synthesis is required for users. Language translation is also important.

As a result of the sudden popularity of these smart speaker devices, new uses for these device are needed. One area that smart speakers can provide a particular advantage is in the taking of surveys for medical, political, and marketing purposes. The typed word lacks emphasis, inflection and other paralinguistic information, metadata that is readily available from the spoken word. But existing devices do not capture nor analyze this metadata. There is a need in the industry to capture and use this metadata to enhance the information from online surveys.

Paralinguistics includes a significant amount of information. Inflection, intonation, tone, loudness, pitch, and other information is available. Consider all the different ways simply changing your tone of voice might change the meaning of a sentence. A friend might ask you how you are doing, and you might respond with the standard “I'm fine,” but how you actually say those words might reveal a tremendous amount of how you are really feeling. A cold tone of voice might suggest that you are actually not fine, but you don't wish to discuss it. A bright, happy tone of voice will reveal that you are actually doing quite well. A somber, downcast tone would indicate that you are the opposite of fine and that perhaps your friend should inquire further. For a survey, this information can provide completely different information than a simple poll will provide.

Note that surveys are not polls. A poll requires a predetermined answer to a question, and only uses that fixed answer. Polls ask yes or no questions, or on a scale of one to five type questions. Polls force the subject into fixed answers that are easily counted and processed into a result.

In contrast, a survey is a series of questions that can accept flexible answers. Open ended questions are more often used, and information is extracted from the words the subject uses. In addition, some embodiments of the present invention use paralinguistic metadata from the subjects voice, extracting inflection, tone, and emotion from the spoken words. The answers to a survey are fuzzy and abstract, where the answers to a poll are specific and deterministic.

There is a need in the industry for a device, either a smart speaker or a computing device that contains special algorithms to transform the device to deal with surveys.

### BRIEF SUMMARY OF INVENTION

A smart speaker apparatus for controlling a survey is described. The smart speaker has an electronic bus electrically connected to a special purpose central processing unit, a network interface (that is also connected to a network of computing devices), a speaker, a microphone, and a memory. The memory contains several software modules that contain instructions for the special purpose central processing unit. One of these modules directs the speaker to speak a verbal survey question and to receive a survey response to the survey question with the microphone, storing said survey response in the memory. A second module contains instructions for the special purpose central processing unit to parse the survey response into text words and use a weighted word algorithm to determine a weighted answer. A third module contains instructions for the special purpose central processing unit to transmit the weighted answer to a remote database.

In some embodiments, a fourth module translates the text words into a different language. In some embodiments, a fifth module extracts paralinguistic metadata from the survey response. The survey response could include both verbal and non-verbal information. The network could be the internet. The smart apparatus could not have a visual display. The parsing of the survey response into text words could be done as each word is received by the microphone, “on the fly”.

A method for conducting surveys using a smart speaker apparatus is also described herein. The method is made up of the steps of (1) speaking a survey question through a speaker in the smart speaker apparatus, (2) listening for a survey response though a microphone on the smart speaker apparatus, (3) storing the survey responses in a memory on the smart speaker system, (4) parsing the survey response into text words by a special purpose central processing unit on the smart survey speaker apparatus, (5) analyzing the text words with a weighted word algorithm to determine a weighted answer; and (6) transmitting the weighted answer to a remote database.

In some embodiments the method comprises the step of (7) translating the text words into a different language and/or (8) extracting paralinguistic metadata from the survey response. The survey response could include both verbal and non-verbal information, and the network could be the internet. The parsing of the survey response into text words could be done as each word is received by the microphone, “on the fly”.

A system for conducting survey is also described. The system is made up of a smart speaker apparatus, a survey computer and a network. The smart speaker has an electronic bus electrically connected to a special purpose central processing unit, a network interface (that is also connected to a network of computing devices), a speaker, a microphone, and a memory. The memory contains several software modules that contain instructions for the special purpose central processing unit. One of these modules directs the speaker to speak a verbal survey question and to receive a survey response to the survey question with the microphone, wherein data regarding the survey response is sent to the network through the network interface. The survey server is made up of (1) a server network interface electrically connected to the network of computing devices, (2) a server central processing unit electrically connected to the server network interface, and (3) a database connected to the server central processing unit, wherein the database contains survey questions and survey answers. In this system the survey response is parsed into text words and a weighted word algorithm is used to determine a weighted answer, and the weighted answer stored in the database.

In some embodiments, the database is connected to the server central processing unit through a network. The database could be a relational database system. The system could translate the text words into a different language. The survey response could include both verbal and non-verbal information. Paralinguistic metadata could be extracted from the survey response. The smart speaker apparatus could not include a visual display.

### BRIEF DESCRIPTION OF THE DRAWINGS

FIG. 1 shows a functional block diagram of the components of the system.

FIG. 2 shows a software block diagram of the smart speaker survey system.

FIG. 3 is a sample survey dialog.

FIG. 4 shows the message flow among the components of the system.

FIG. 5 shows an electrical diagram of the components of the smart speaker device.

### DETAILED DESCRIPTION

The present inventions involve the techniques for taking surveys on computers and smart speaker devices. Surveys taking, with open ended questions and paralinguistic interpretation, is a highly complex task, and requires special algorithms and special uses for the computing equipment. These special algorithms transform the smart speaker or other computing device into a device capable of conducting surveys.

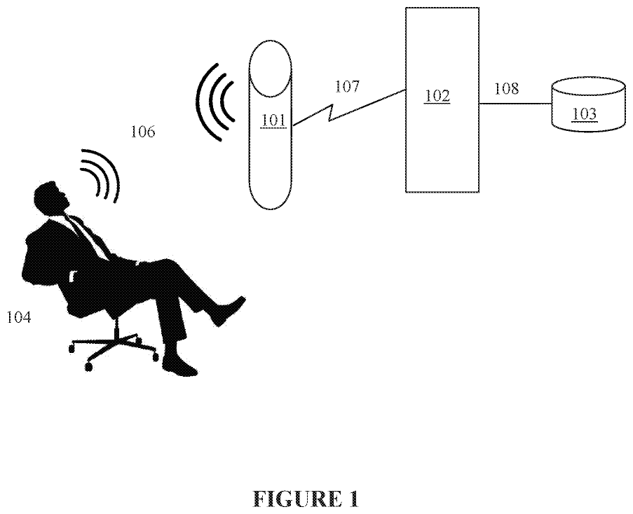

Looking to FIG. 1, there is a diagram of a person 104 taking a survey on a smart speaker 101. In this embodiment, the person 104 listens to the survey questions as presented through the air 106 by the smart speaker 101. The smart speaker 101 is in communications with a survey server 102 through a wireless and/or wired network 107. The survey server 102 communicates over a wireless and/or wired network 108 with a database 103. In some embodiments, the database 103 is directly connected or incorporated into the survey server 102. In embodiments network 107 and 108 are the same network. Either or both networks 107, 108 could be the internet.

The survey questions are stored in the database 103. The survey server 102 retrieves the survey questions from the database 103 using the network 108. The survey server 102 then sends the questions as text to the smart speaker 101 through the wireless network 107. The smart speaker 101 uses sound synthesis algorithms to convert the text questions into audio questions. In some embodiments, the sound synthesis happens in the survey server 102, with audio files transferred to the smart speaker 101. In still another embodiment, the questions are stored as audio files in the database 103 and the audio files are transferred through the two networks 107, 108. In some embodiments, the survey server 102 translates the text into another language before transferring the text to the speech synthesis algorithms.

Once the smart server 101 has the audio files ready, they are transmitted through the speaker 507 through the air 106 to the person 104. The person 104 responds to the survey questions by speaking back through the air 106 to the smart speaker 101. The smart speaker 101 records the audio from the person 104, typically through a microphone 505. In one embodiment, this recording is sent to the database 103 through the networks 107, 108 to allow for future review. In another embodiment, the audio is converted in to text at the smart speaker 101 and only text is transmitted to the database 103.

In addition to the storage of the recording, the smart speaker 101 (or in some embodiments the survey server 102) interpret the spoken words and convert the words into text. In some embodiments, the text is translated into another language by either the smart speaker 101 or the survey server 102. In still a third embodiment, the translation is done by another server on the Internet.

The text is stored in the database 103. In addition, the paralinguistic characteristics of the person's 104 response are analyzed and stored in the database 103.

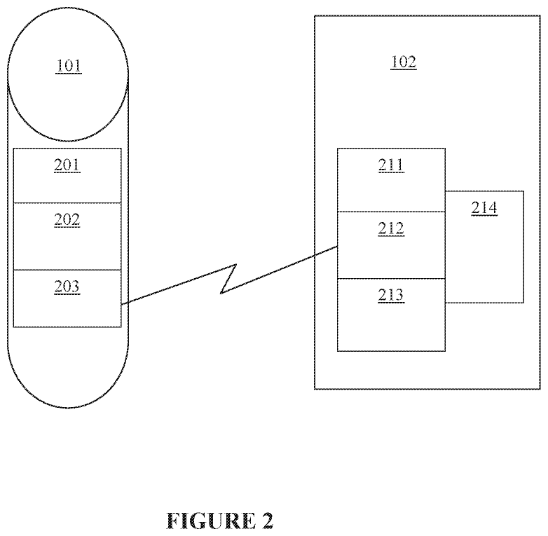

FIG. 2 shows a software architecture of the survey mechanism. Note that while we assign functions to various devices in this discussion, software modules could be moved to different devices without detracting from the invention.

The smart speaker device 101 is under the control of the smart speaker operating system 201. Examples of this operating system include Android for the Google Assistant, iOS for the Apple HomePod, or Amazon Echo's variant of the Linux operating system. The operating system 201 provides the drivers and tasking support for the smart speaker 101. In addition, it provides the APIs and the operating envelope for various applications to run on the smart speaker 101. In the case of the Amazon Echo, the operating system 201 supports applications, called “skills”, that can run on the smart speaker 101 system. The operating system 201 runs constantly on smart speaker 101, listening to the microphone 505 for keywords indicating that the smart speaker 101 is being addressed by a person 104. In the case of the Amazon Echo, the keyword is “Alexa”. When the smart speaker 101 hears the word “Alexa”, the device listens for the following words and interprets them as instructions for the device. If the person 104 says “Hey Alexa, launch Voice Rewards”, the Amazon Echo operating system 201 parses the spoken words “Alexa” to cause the device to start listening, “launch” to determine that a skill is to be launched, and “Voice Rewards” as the name of the skill to launch. The Amazon Echo operating system 201 then starts the “Voice Rewards” skill 202 and hands control over to the skill.

The Voice Rewards skill 202 operates under the control of the operating system 201 and uses the services of the operating system to access the speaker, microphone, LEDs, and the network. Additional application programming interfaces (APIs) 203 could be used to provide a layered approach to the survey server 102 services 212.

The Voice Rewards skill 202, once initiated by the operating system 201 first checks that the user 104 wants to work on a survey and that the user is requesting a survey. Then the skill 202 asks the user 104 which survey that he wants to take. The skill 202 provides the list of available surveys and the user 104 selects a survey. See the code snippet below:

```
def get_welcome_response(session):
      if ‘attributes’ in session:
            session_attributes = session[‘attributes’]
      else:
            session_attributes = { }
      card_title = None
      reprompt_text = None
            should_end_session = False
            company_survey = check_company({ },session)
            try:
                  token = session[‘user’][‘accessToken’]
            except:
                  return promptRegister( )
            survey_types = getSurveys(token, session)
            if survey_types == False:
                  survey_types = getSurveys(token, session)
                  if survey_types == False:
                        speech_output = “Sorry, I had an issue getting the list of
      surveys. We appreciate your interest in Voice Rewards. I'm working to resolve
      the issue. Please try again in a little while. <audio
      src=\“https://s3.amazonaws.com/truereply/intro_low_alexa.mp3\” />”
                        should_end_session = True
                        return build_response({ }, build_speechlet_response(None,
      speech_output, None, should_end_session))
            if len(survey_types) > 1:
                  response = {
                              ‘outputSpeech’: {
                                    ‘type’: ‘SSML’,
                                    ‘ssml’: “<speak><audio
      src=\“https://s3.amazonaws.com/truereply/intro_low_alexa.mp3\” /> Welcome to
      Voice Rewards. There are “ + str(len(survey_types)) + ” surveys available. Would
      you like to list them now?</speak>”
                              },
                              ‘reprompt’: {
                                    ‘outputSpeech’: {
                                          ‘type’: ‘PlainText’,
                                          ‘text’: “To take a survey, say
      something like I want to take a survey.”
                                    }
                              },
                              ‘shouldEndSession’: False
                  }
            else:
                  if len(survey_types) == 0:
                        speech_output = “<audio
      src=\“https://s3.amazonaws.com/truereply/intro_low_alexa.mp3\” />There are no
      surveys available right now. Check back daily for new surveys. Login at Voice
      Rewards Dot Me to review and withdrawal your rewards. Thank you for
      participating in Voice Rewards. Good Bye! <audio
      src=\“https://s3.amazonaws.com/truereply/intro_low_alexa..mp.3\” />”
                        should_end_session = True
                        return build_response(session_attributes,
      build_speechlet_response(card_title, speech_output, reprompt_text,
      should_end_session))
                  else:
                        response = {
                                    ‘outputSpeech’: {
                                          ‘type’: ‘SSML’,
                                          ‘ssml’: “<speak><audio
    src=\“https://s3.amazonaws.com/truereply/intro_low_alexa.mp3\” /> Welcome to
    Voice Rewards: There is “ + str(len(survey_types)) + “ survey available: Would
    you like to list it now?</speak>”
                                    },
                                    ‘reprompt’: {
                                          ‘outputSpeech’: {
                                                ‘type’: ‘PlainText’,
                                                ‘text’: “To take a survey, say
      something like 1 want to take a survey.”
                                          }
                                    },
                                    ‘shouldEndSession’: False
                        }
            return build_response({“route”: “surveyList”, “company”:
      company_survey}, response)
      # Events
            The function build_response prepares the response received from the user
104. Note that the build_response function could be expanded to translate the text into a
different language in some embodiments. In addition, build_response could also analyze
the response for paralinguistic information.
def build_response(session_attributes, speechlet_response):
      return {
            ‘version’: ‘1.0’,
            ‘sessionAttributes’: session_attributes,
            ‘response’: speechlet_response
      }
```

Once the survey is selected, the skill 202 then cycles through the questions of the survey and receives the responses from the user 104. See the general survey handling code below:

```
def surveyAction(intent,session):
      session_attributes = { }
      card_title = None
      reprompt_text = None
      should_end_session = True
      company_survey = check_company(intent, session
      skill_id = session[‘user’][‘userId’]
      try:
            user_token = session[‘user’][‘accessToken’]
      except:
            return promptRegister( )
      if “route” in session[‘attributes’]:
            route = session[‘attributes’][‘route’]
      else:
            route = “”
      if route == “surveyChoose”:
            try:
                  slotValue = intent[‘slots’][‘response’][‘value’]
            except KeyError:
                  try:
                        slotValue = intent[‘slots’][‘choice’][‘value’]
                  except KeyError:
                        slotValue = “”
            if slotValue.isdigit( ) == False:
                  if slotValue == “repeat”:
                        return promptRepeat(session)
                  survey_types = getSurveys(user_token, session)
                  if survey_types == False:
                        survey_types = getSurveys(user_token, session)
                        if survey_types == False:
                              speech_output = “Sorry, I had an issue
getting the list of surveys. We appreciate your interest in Voice Rewards. I'm
working to resolve the issue. Please try again in a little while. <audio
src=\“https://s3.amazonaws.com/truereply/intro_low_alexa.mp3\” />”
                              should_end_session = True
                              return build_response(session_attributes,
build_speechlet_response(card_title, speech_output, reprompt_text,
should_end_session))
                  speech_output = “Please say the number of the survey you
would like to take. Or say Repeat to hear the list of available surveys again.”
                  reprompt_text = speech_output
                  session_attributes = {
                        “route”: “surveyChoose”,
                        “survey_types”: survey_types,
                        “current_page”:
int(session[‘attributes’][‘current_page’]),
                        “company”:company_survey
                  }
                  should_end_session =“False
                  return build_response(session_attributes,
build_speechlet_response(card_title, speech_output, reprompt_text,
should_end_session))
            else:
                  survey_types =“session[‘attributes’][‘survey_types’]
                  survey_choice =“int(intent[‘slots’][‘choice’][‘value’])
                  page_number =“int(session[‘attributes’][‘current_page’])
                  if survey_choice == 4:
                        route = “surveyList”
                  else:
                        survey_choice = survey_choice + ((page_number −
1) * 3)
                        try:
                              chosen_survey =
survey_types[survey_choice − 1]
                        except KeyError:
                              speech_output = “Please make a valid
selection.”
                              should_end_session = False
                              session_attributes = session[‘attributes’]
                              return build_response(session_attributes,
build_speechlet_response(None, speech_output, reprompt_text,
should_end_session))
                        speech_output = “You chose the ” +
chosen_survey[1] + “! It has ” + str(chosen_survey[2]) + “ questions, and you will
earn ” + rateType(chosen_survey[3],chosen_survey[4]) + “ by completing the
survey. Please minimize background noise and make sure you are within range of
your device while taking your survey. Ready to get started?”
                        session_attributes = {
                              “route”: “startSurvey”,
                              “survey_type”: chosen_survey[0],
                              “survey_length”: chosen_survey[2],
                              “questions”:
getQuestions(chosen_surey[0]),
                              “current_item”: 0,
                              “company”:company_survey
                        }
                        should_end_session = False
                        return build_response(session_attributes,
build_speechlet_response(chosen_survey[1], speech_output, reprompt_text,
should_end_session))
      elif route == “startSurvey”:
            try:
                  survey_type = session[‘attributes’][‘survey_type’]
                  current_item = session[‘attributes’][‘current_item’]
            except KeyError:
                  pass
            survey_questions = getQuestions(survey_type)
            survey_question = survey_questions[current_item][1]
            survey_question_id = survey_questions[current_item][0]
            should_end_session = False
            opener = randint(1,4)
            if opener == 1:
                  speech_output = “Sure thing! ”
            elif opener == 2:
                  speech_output = “Okay, ”
            elif opener == 3:
                  speech_output = “Alright, let's get started. ”
            elif opener == 4:
                  speech_output = “Alright, here we go. ”
            speech_output += “ Here's your first question. ” + survey_question
            session_attributes = {
                  “route”: “doSurvey”,
                  “current_item”: current_item+1,
                  “survey_length”: session[‘attributes’][‘survey_length’],
                  “questions”: session[‘attributes’][‘questions’],
                  “previous_item”: current_item,
                  “survey_type”: survey_type,
                  “company”: company_survey
            }
            return build_response(session_attributes,
build_speechlet_response(card_title, speech_output, reprompt_text,
should_end_session))
      elif route == “doSurvey”:
            try:
                  if ‘value’ in intent[‘slots’][‘choice’]:
                        inten[‘slots’][‘response’][‘value’] =
str(intent[‘slots’][‘choice’][‘value’])
            except KeyError:
                  if intent[‘name’] == “AMAZON.YesIntent”:
                        intent[‘slots’] = { }
                        intent[‘slots’][‘response’] = { }
                        intent[‘slots’][‘response’][‘value’] = “Yes.”
                  elif intent[‘name’] == “AMAZON.NoIntent”:
                        intent[‘slots’] = { }
                        intent[‘slots’][‘response’] = { }
                        intent[‘slots’][‘response’][‘value’] = “No.”
            try:
                  survey_type = session[‘attributes’][‘survey_type’]
                  current_item = session[‘attributes’][‘current_item’]
                  previous_item = session[‘attributes’][‘previous_item’]
                  try:
                        response = intent[‘slots’][‘response’][‘value’]
                  except KeyError:
                        response = intent[‘slots’][‘choice’][‘value’]
            except KeyError:
                  speech_output = “Sorry, I didn't understand your response.
We appreciate your interest in Voice Rewards. I'm working to resolve the issue.
Please try again in a little while. <audio
src=\“https://s3.amazonaws.com/truereply/intro_low_alexa.mp3\” />”
                  should_end_session = False
                  session_attributes = session[‘attributes’]
                  return build_response(session_attributes,
build_speechlet_response(card_title, speech_output, reprompt_text,
should_end_session))
            if current_item >= int(session[‘attributes’][‘survey_length’]):
                  survey_questions = getQuestions(survey_type)
                  survey_question = survey_questions[−1][1]
                  survey_question_id = survey_questions[−1][0]
                  if sendResponse(survey_type, survey_question_id,
response, user_token) == False:
                        if sendResponse(survey_type, survey_question_id,
response, user_token) == False:
                              speech_output = “Sorry, I had an issue
saving your response. I'm working to resolve the issue now. Please try again to
take this survey again in a little while. <audio
src=\“https://s3.amazonaws.com/truereply/intro_low_alexa.mp3\” />”
                              should_end_session = True
                              return build_response(session_attributes,
build_speechlet_response(card_title, speech_output, reprompt_text,
should_end_session))
                  upCount(session[‘attributes’][‘survey_type’])
                  speech_output = “Thank you for completing this survey!
Would you like to take another?”
                  should_end_session = False
                  session_attributes = {
                        “route”: “finishedSurvey”,
                        “company”:company_survey
                  }
                  return build_response(session_attributes,
build_speechlet_response(card_title, speech_output, reprompt_text,
should_end_session))
            else:
                  survey_questions = getQuestions(survey_type)
                  survey_question = survey_questions[current_item][1]
                  survey_question_id = survey_questions[previous_item][0]
            if sendResponse(survey_type, survey_question_id, response,
user_token) == False:
                  if sendResponse(survey_type, survey_question_id,
response, user_token) == False:
                        speech_output = “Sorry, I had an issue sending your
response. We appreciate your interest in Voice Rewards. I'm working to resolve
the issue. Please try again in a little while. <audio
src=\“https://s3.amazonaws.com/truereply/intro_low_alexa.mp3\” />”
                        should_end_session = True
                        return build_response({ },
build_speechlet_response(card_title, speech_output, reprompt_text,
should_end_session))
            if survey_question == False:
                  speech_output = “Sorry, I had an issue getting that
question. We appreciate your interest in Voice Rewards. I'm working to resolve
the issue. Please try again in a little while. <audio
src=\“https://s3.amazonaws.com/truereply/intro_low_alexa.mp3\” />”
                  should_end_session = True
                  return build_response({ }, build_speechlet_esponse(
card_title, speech_output, reprompt_text, should_end_session))
            opener = randint(1,4)
            if opener == 1:
                  speech_output = “Okay, I got it! ”
            elif opener == 2:
                  speech_output = “Thanks for that! ”
            elif opener == 3:
                  speech_output = “Great, ”
            elif opener == 4:
                  speech_output = “Alright, ”
            speech_output += “ Here's your next question. “ + survey_question
            should_end_session = False
            session_attributes = {
                  “route”: “doSurvey”,
                  “current_item”: current_item + 1,
                  “previous_item”: current_item,
                  “survey_length”: session[‘attributes’][‘survey_length’],
                  “questions”: session[‘attributes’][‘questions’],
                  “survey_type”: survey_type,
                  “company”:company_survey
            }
            return build_response(session_attributes,
build_speechlet_response(card_title, speech_output, reprompt_text,
should_end_session))
      if route == “surveyList”:
            speech_output = “Sorry, I had an issue getting the list of surveys.
We appreciate your interest in Voice Rewards. I'm working to resolve the issue.
Please try again in a little while. <audio
src=\“https://s3.amazonaws.com/truereply/intro_low_alexa.mp3\” />”
            survey_types = getSurveys(user_token, session)
            if survey_types == False:
                  survey_types = getSurveys(user_token, session)
                  if survey_types == False:
                        speech_output = “Sorry, I had an issue getting the
list of surveys. We appreciate your interest in Voice Rewards. I'm working to
resolve the issue. Please try again in a little while. <audio
src=\“https://s3.amazonaws.com/truereply/intro_low_alexa.mp3\” />”
                        should_end_session = True
                        return build_response(session_attributes,
build_speechlet_respose(card_title, speech_output, reprompt_text,
should_end_session))
            if(len(survey_types) > 2):
                  if not “current_page” in session[‘attributes’]:
                        current_page = 1
                  else:
                        if session[‘attributes‘][“current_page”] == None:
                              current_page = 1
                        else:
                              try:
                                    current_page =
session[‘attributes’][“current_page”] + 1
                              except KeyError:
                                    current_page = 1
                  i = 1
                  startIndex = (current_page − 1) * 3
                  endIndex = startIndex + 3
                  if (endIndex >= len(survey_types)):
                        endIndex = len(survey_types)
                        last_page = True
                  else:
                        last_page = False
                  speech_output = “”
                  for survey_type in survey_types[startIndex:endIndex]:
                        survey_number = i + ((current_page − 1) * 3)
                        speech_output += “To take a survey about ” +
survey_type[1] + “ and earn ” + rateType(survey_type[3],survey_type[4]) + “,
please say ” + str(i) + “, ”
                        i = i + 1
                  else:
                        if not last_page == True:
                              speech_output += “or say 4 to list more
surveys.”
                  session_attributes = {
                        “route”: “surveyChoose”,
                        “survey_types”: survey_types,
                        “current_page”: current_page,
                        “company”:company_survey
                  }
                  should_end_session = False
            elif (len(survey_types) == 2):
                  speech_output = “To take a survey about ” +
survey_types[0][1] + “ and earn ” +
rateType(survey_types[0][3],survey_types[0][4]) + “, please say one, To take a
survey about ” + survey_types[1][1] + “ and earn $” + survey_types[1][3] + “,
please say two.”
                  session_attributes = {
                        “route“: “surveyChoose”,
                        “survey_types”: survey_types,
                        “current_page”: 1,
                        “company”:company_survey
                  }
                  should_end_session = False
            elif (len(survey_types) == 1):
                  speech_output = “To take a survey about ” +
survey_types[0][1] + “ and earn ” +
rateType(survey_types[0][3],survey_types[0][4]) + “, please say one.”
                  session_attributes = {
                        “route”: “surveyChoose”;
                        “survey_types”: survey_types,
                        “current_page”: 1,
                        “company”:company_survey
                  }
                  should_end_session = False
            else:
                  platform_text = “”
                  if company_survey != False and company_survey != “”:
                        platform_text = company_survey
                  speech_output = “There are no more ”+platform_text+”
surveys available right now. Check back daily for new surveys. Login at Voice
Rewards Dot Me to review and withdrawal your rewards. Thank you for
participating in Voice Rewards, Good Bye! <audio
src=\“https://s3.amazonaws.com/truereply/intro_low_alexa.mp3\” />”
                  should_end_session = True
            return build_response(session_attributes,
build_speechlet_response(card_title, speech output, reprompt_text,
should_end_session))
      return promptRepeat(session)
```

Turning to the right side of FIG. 2, the survey server 102 software architecture is defined. The operating system 211 manages the software and provides services on the survey server 102.

One portion of the software is the server side application program interface (API) 212. This API 212 handles messages from the smart speaker side API 18 203. Server side API 212 accepts messages and dispatches commands to the appropriate function on the server 102. These functions could be the database interface 213 or to various server 102 software 214 such as translation, paralinguistic analysis, and similar.

The database interface 213 is a set of calls to the relational database system (RDBS) system. These calls include the retrieval of the survey question, the storage of the survey responses, the storage of the recording of the responses, the paralinguistic meta-data associated with the response. In addition, there is a software interface to provide the data in the database to the Voice Rewards dashboard 401 so that the survey designer can store a new survey and see the results.

In one embodiment, a user 104 uses the smart speaker 101 to take a survey for a fee. Users 104 register via a webpage (VoiceRewards.me, for example) by providing a complete profile of demographic and psychographic data that will be used for future targeting of voice-based surveys. Users 104 also have the option of beginning their engagement with VoiceRewards.me via their Amazon Alexa-powered device 101 and then completing their registration on the website before initiating a cash out of earnings. Users 104 will be guided on how to install the skill 202 using either their Amazon Alexa-powered device 101 or using the Amazon Alexa Companion App. Installing via their device 101 requires only asking “Alexa, install Voice Rewards.” This will provide an action button via VoiceRewards.me to install the Alexa Skill via their mobile phone.

Available surveys become part of their Daily News Briefing via Amazon Alexa 101. To engage new surveys, users simply have to request “Alexa, launch Voice Rewards” and are then greeted with “Welcome to Voice Rewards . . . we have _____ surveys available. Would you like me to list them?”

Users 104 can then pick the surveys that interests them, and participate by answering questions in their own voice. Upon completion, the user's Voice Rewards account will be credited with the dollar amount offered by the advertiser for their participation. The user 104 then has the option to cash out that amount to their PayPal account as cash, or out to their favorite cryptocurrency. They also have the option to cash out to the True Reply research token, the Reply token.

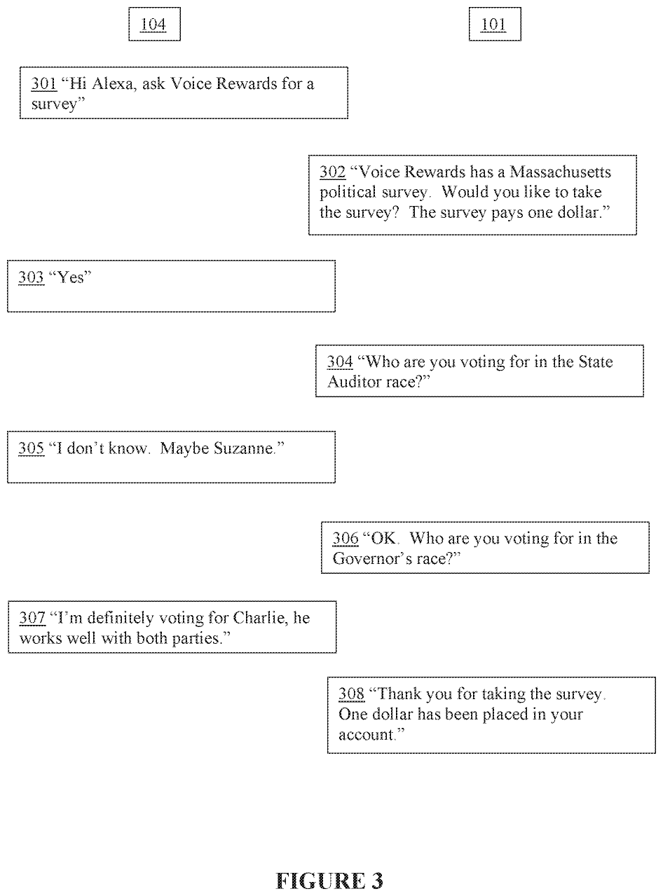

FIG. 3 is a sample survey dialog between the user 104 and the smart speaker 101. The survey conversation starts with the user 104 asking the smart speaker 101 for a survey 301, “Hi Alexa, ask Voice Rewards for a survey”. The smart speaker 101 operating system 201 stops idling when it hears “Alexa”, and listens for the instruction “ask” and the parameters of the instruction “Voice Rewards”. The smart speaker 101 continues to receive the words “for a survey” and passes these words to the Voice Rewards skill 202. The Voice Rewards skill 202 is started and uses the “for a survey” words to execute the code to query the database 103 through the survey server 102 for a list of active surveys. The survey server 102 also checks which surveys that the user 104 has already taken and eliminates those surveys from the list.

The survey server 102 returns a list of untaken active surveys to the smart speaker 101 for articulating to the user 104. In the example in FIG. 3, only one survey is found 302. The smart speaker 101 states: “Voice Rewards has a Massachusetts political survey. Would you like to take the survey? The survey pays one dollar.” This indicates that the user 101 will receive a payment for taking the survey. The user can accept or decline the survey 303, and in this case the user 104 accepts the survey. The code in the Voice Rewards skill 202 notes the acceptance, and queries, through the APIs 203, 212, 213 to the database 103 for the survey questions. The questions from the database 103 are sent to the smart speaker 101 through the server 102 and the networks 107, 108.

The smart speaker 101 presents the question 304 to the user 104: “Who are you voting for in the State Auditor race?” The user 101 response ambivalently 305, “I don't know. Maybe Suzanne.” In this response, the words, even without the paralinguistic data, demonstrates a lack of conviction in the answer. “Maybe”, “Don't know” are negative words that demonstrate a lack of commitment to the answer. A poll would record this answer as a vote for Suzanne. But the survey show a very different answer because of the ambivalence of the answer. A survey score is a very soft yes or a possible no. For a politician, this survey answer provides the most important result, a voter who could be convinced to change.

Contrast this answer to the next questions 306: “Who are you voting for in the Governor's race?” Here, the answer 307 is given with much more conviction:“I'm definitely voting for Charlie, he works well with both parties”. Positive, assertive words are used, “definitely” “works well”. For the survey designer, these answers make it clear that the user 101 has made up his mind, and is unlikely to change.

In the automation of the analysis of the survey results, the answers 305, 307 are each parsed, converted to text, and analyzed using a stop word algorithm. Stop words are words which are filtered out before or after processing of natural language data (text). The stop word algorithm removes these common words from the answers 305, 307. For instance, words like “is, a, the, is, at, which, on, and, I, for” are removed from the analysis. Parsing could be done on the completed answer or the response could be parsed on the fly, word by word as the response is received.

Next, each word assigned a value relative to the strength of the word using a weighted word algorithm. The weighted value of the words is taken from a database. This could be the database 103 or a local list stored on the smart speaker 101. “Definitely” has a high positive value and “Maybe” has a negative value. The weight of the words in the answer is then combined with the answer itself. The answer is done by looking up the words to see if there is a positive or a negative response. In the second answer 307, the word “for” is a positive response, and may be assigned a straight positive response of one. The word “maybe” is also positive, but a weak positive, so it is assigned a weaker value of 0.5. This is combined with the weak “don't know”, to give the first answer a weak 0.25 positive. The second answer, with the word “definitely” providing an empathetic positive response, when combined with the word “for” provides a value of

In a similar way, the paralinguistic information is parsed and interpreted to create a weighted value that is further factored into the value of the answer. So if the user 104 answers with a loud, assertive tone, the weighting for the answer increases. If the user answers slowly, hesitantly, quietly, the weighting is decreased.

Once the survey is completed, the smart speaker closes the survey and assures the user 101 that a payment has been made 308.

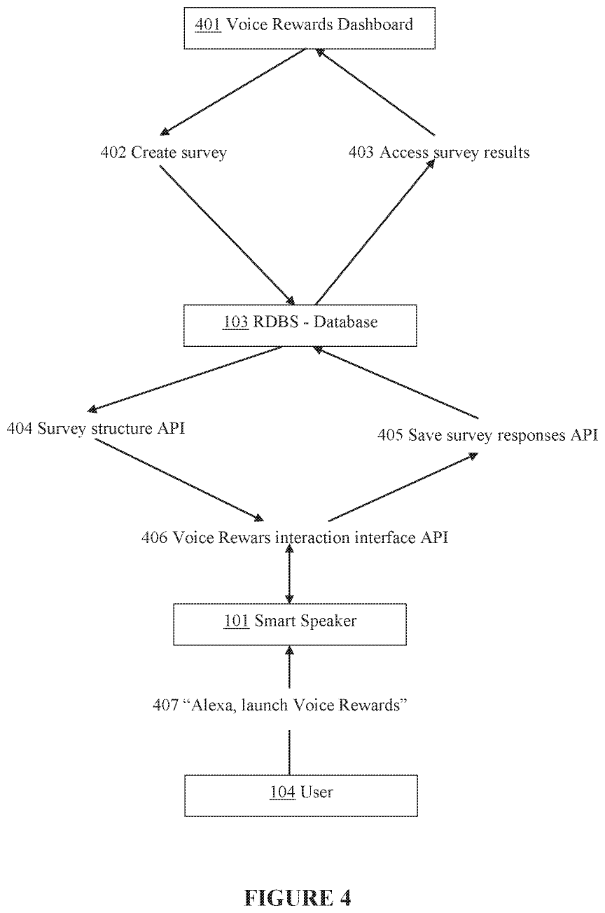

Turning to FIG. 4, we see the flow of messages throughout the survey system. The Voice Rewards Dashboard 401 is used to create the survey questions, to create weighted lists, and to input other parameters of the survey (geographic limits of the survey, lists of users who are allowed or not allowed to take the survey, etc). In addition, the dashboard 401 presents the data from the survey at multiple levels. One level is the synthesis of all of the answers, where each answer to each question is merged into a weighted score of the answer. Another way of looking at the score is a word cloud analysis. Still a third view is the text of each of the answers received. And finally, there is the ability to listen to the audio of each answer.

The dashboard 401 is used to create the survey 402 that is stored in the RDBS database 103. The RDBS database 103 makes the survey structure available through the survey access API 404. The survey is assembled in the Voice Rewards interaction interface API 406. The smart speaker 101 uses the interaction interface API 406 to obtain the survey questions. The user 104 initiates the messages with a command 407 to the smart speaker 101.

The message flow the returns in a similar manner. The user 104 replies to a question by speaking at the smart speaker 101. The smart speaker 101 provides the answer to the interaction interface API 406. The answers are then sent to the Save survey responses API 405, that saves both the complete audio and the parsed text responses. The responses API 405 stores this data in the RDBS database 103. The Voice Rewards dashboard 401 then retrieves the data from the database 103 for display of the results.

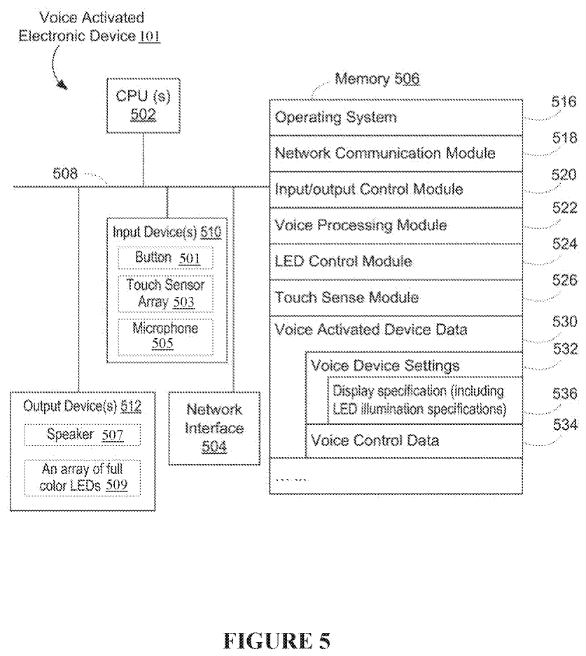

FIG. 5 is a detailed electrical diagram of one embodiment of the smart speaker (aka voice activated electronic device) 101. The smart speaker 101 has an electrical bus 508 connecting the components of the device. The smart speaker 101 contains one or more special purpose central processing units (CPUs) 502, one or more network interfaces 504, memory 506, and one or more communication buses 508 for interconnecting these components (in some embodiments this functionality is incorporated in a chipset). The smart speaker 101 includes one or more input devices 510 that facilitate user input, such as the button 501, the touch sense array 503 and the one or more microphones 505. The smart speaker 101 also includes one or more output devices 512, including one or more speakers 507 and may include an array of full color LEDs 509. Some embodiments may also include a screen and video processing units.

The special purpose central processing units 502, in some embodiments, differ from standard CPUs in that they do not have display processing components. Furthermore, in some embodiments, the special purpose central processing units 502 include additional transistors to enhance the speech synthesis functions and the microphone input processing. For instance, some special purpose CPUs 502 could include voice parsing with the CPU.

The memory 506 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 506, optionally, includes one or more storage devices remotely located from one or more processing units 502. Memory 506, or alternatively the non-volatile memory within memory 506, includes a non-transitory computer readable storage medium. In some implementations, memory 506, or the non-transitory computer readable storage medium of memory 506, stores the following programs, modules, and data structures, or a subset or superset thereof:

The operating system 516 (a subset of the operating system 201 includes procedures for handling various basic system services and for performing hardware dependent tasks.

The network communication module 518 is for connecting the smart speaker 101 to other devices (e.g., the survey server 102) via one or more network interfaces 504 (wired or wireless) and one or more networks 107, 108, such as the Internet, other wide area networks, local area networks, metropolitan area networks, and so on.

The input/output control module is for receiving inputs via one or more input devices 510 enabling presentation of information at the smart speaker 101 via one or more output devices 512, including:

Voice processing module 522 for processing audio inputs or voice messages collected in an environment surrounding the smart speaker 101, or preparing the collected audio inputs or voice messages for processing at a voice processing or language processing software on the survey server 102;

LED control module 524 for generating visual patterns on the full color LEDs 509 according to device states of the smart speaker 101; and

Touch sense module 526 for sensing touch events on a top surface of the smart speaker 101; and

Voice activated device data 530 storing at least data associated with the smart speaker 101, including:

Voice device settings 532 for storing information associated with the smart speaker 101 itself, including common device settings (e.g., service tier, device model, storage capacity, processing capabilities, communication capabilities, etc.), information of a user account in a user domain, and display specifications 536 associated with one or more visual patterns displayed by the full color LEDs; and

Voice control data 534 for storing audio signals, voice messages, response messages and other data related to voice interface functions of the smart speaker 101.

In the above descriptions, the smart speaker 101 could be replaced by a personal computer, a laptop, a smart phone, a tablet, or a smart watch, provided that the device contained a microphone and a speaker.

In still another embodiment, the smart speaker 101 could be installed in an automobile. Recently, BMW and Ford announced that they are installing Amazon Alexa powered voice interfaces in their automobiles. The survey applications described herein could be implemented in automobiles, providing the user 104 with the ability to take surveys while driving. In addition, a survey could be created to detect impairment of the driver by asking questions and analyzing the responses both for word choices and for paralinguistic characteristics. In certain situations, the smart speaker 101 installed in the automobile could disable the vehicle if a certain score is not obtained by the survey. This has the advantage of analyzing the mental state of the driver 104 rather than existing methods that look at other specific indicators. For instance, a breathalyzer looks for specific chemical in the user's breath. Other chemicals are missed, and a totally exhausted driver is not looked for at all. By analyzing the linguistic and paralinguistic answers to a survey, the driver's 104 mental ability to drive can be assessed.

In still another embodiment, consumer products are starting to incorporate speakers and microphones to enable users to talk to their appliances. For instance, a new FireTV will have Alexa built right into the TV. A push of the remote button or a trigger word, and you're talking to your TV. This allows the smart speaker 101 to be a consumer appliance in some embodiments, allowing the appliance to be the device conducting the survey.

The above system provides a significant contribution to the gathering of medical information. When dealing with debilitating diseases, patient attrition is a constant challenge. Once the symptoms of debilitating diseases progress to the point where things as simple as walking or using a computer become painful or uncomfortable, we experience the patient knowledge gap. At this point, medical practitioners efforts to maintain participation levels soon becomes cost prohibitive.

By using the inventions described herein, the survey results were when used in the medical field were exceptional. Patients recorded answers were open and expansive, significantly more than experienced via form based surveys at a comparable cost-basis. Patient participation through smart speaker or telephone created an environment open to them to share the full breadth of the impact of their symptoms in their lives and how they are dealing with that symptom. Specific was insight into the range of self-medication occurring and the broadness of the types of medications used. The need to target specific questions was replaced with an open-ended stream of insight that was profound in the understanding of the symptom in the lives of those afflicted.

Furthermore, the use of open ended survey questions, using smart speakers, for mental health medical situations provides medical practitioners with insight into their patients, particularly when paralinguistic data is collected. Simply asking the question “how are you today” by the smart speaker can provide significant insight into the mental state of the patient. What words are used in the answer? What paralinguistic characteristics are found in the answer? In one embodiment of the present inventions, survey responses are analyzed using the weighted word algorithm and a similar analysis is used on the paralinguistic metadata. If the scoring is below a threshold, the smart speaker automatically calls a medical professional to advise of the patients state of mind. In another embodiment, a text or email could be sent to the medical professional.

Similarly, surveys could be used in a job recruiting situation. Each candidate in a large pool of candidates could be sent a survey. The responses to the survey questions could be analyzed using the weighted word algorithm to sort how interested the candidate is in the job, and the paralinguistic metadata could be further processed to interpret the excitement of the candidate. This survey could be used to efficiently reduce a large pool of candidates down to a short list for human review,

The foregoing devices and operations, including their implementation, will be familiar to, and understood by, those having ordinary skill in the art. All sizes used in this description could be scaled up or down without impacting the scope of these inventions.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A smart speaker apparatus for controlling a survey, comprising:
an electronic bus;
a special purpose central processing unit electronically connected to the bus;
a network interface electronically connected to the bus and to a network of computing devices;
a speaker electrically connected to the bus;
a microphone electrically connected to the bus;
memory, electrically connected to the bus, the memory comprising software modules containing instructions for the special purpose central processing unit to direct the speaker to speak a verbal survey question and to receive a survey response to the survey question with the microphone, storing said survey response in the memory;
said memory further comprising software modules containing instructions for the special purpose central processing unit to parse the survey response into text words and use a weighted word algorithm to determine a weighted answer; and
said memory further comprising software modules containing instructions for the special purpose central processing unit to transmit the weighted answer to a remote database.

2. The smart speaker apparatus of claim 1 wherein the memory further comprising software modules containing instructions for the special purpose central processing unit to translate the text words into a different language.

3. The smart speaker apparatus of claim 1 wherein the survey response includes both verbal and non-verbal information.

4. The smart speaker apparatus of claim 1 wherein the memory further comprising software modules containing instructions for the special purpose central processing unit to extract paralinguistic metadata from the survey response.

5. The smart speaker apparatus of claim I wherein the network is the internet.

6. The smart speaker apparatus of claim 1 wherein the special purpose central processing unit parses the survey response into text words as each word is received by the microphone.

7. The smart speaker apparatus of claim I wherein the apparatus does not include a visual display.

8. A method for conducting surveys using a smart speaker apparatus, the method comprising:
speaking, through a speaker in the smart speaker apparatus, a survey question;
listening, though a microphone on the smart speaker apparatus, for a survey response;
storing, in a memory on the smart speaker system, the survey responses;
parsing, by a special purpose central processing unit on the smart survey speaker apparatus, the survey response into text words;
analyzing the text words with a weighted word algorithm to determine a weighted an saver; and
transmitting the weighted answer to a remote database.

9. The method of claim 8 further comprising the step of translating the text words into a different language.

10. The method of claim 8 wherein the survey response includes both verbal and non-verbal information.

11. The method of claim 8 further comprising the step of extracting paralinguistic metadata from the survey response.

12. The method of claim 8 wherein the network is the internet.

13. The method of claim 8 wherein the special purpose central processing unit parses the survey response into text words as each word is received by the microphone.

14. A system for conducting surveys, comprising:
a smart speaker apparatus comprising:
an electronic bus;
a special purpose central processing unit electronically connected to the bus;
a network interface electronically connected to the bus and to a network of computing devices;
a speaker electrically connected to the bus;
a microphone electrically connected to the bus;
memory, electrically connected to the bus, the memory comprising software modules containing instructions for the special purpose central processing unit to direct the speaker to speak a verbal survey question and to receive a survey response to the survey question with the microphone, wherein data regarding the survey response is sent to the network through the network interface;
a survey server comprising:
a server network interface electrically connected to the network of computing devices;
a server central processing unit electrically connected to the server network interface;
a database connected to the server central processing unit, wherein the database contains survey questions and survey answers;
wherein the survey response is parsed into text words and a weighted word algorithm is used to determine a weighted answer, the weighted answer stored in the database.

15. The system of claim 14 wherein the database is connected to the server central processing unit through a network.

16. The system of claim 14 wherein the database is a relational database system.

17. The system of claim 14 wherein the text words are translated into different language.

18. The system of claim 14 wherein the survey response includes both verbal and non-verbal information.

19. The system of claim 14 wherein paralinguistic metadata is extracted from the survey response.

20. The system of claim 14 wherein the smart speaker apparatus does not include a visual display.
